(19) United States
(12) Patent Application Publication
(10) Pub. No.: US 2016/0053982 A1
(43) Pub. Date: Feb. 25, 2016

(54) OUTDOOR LIGHTING FIXTURE

(71) Applicant: Spring City Electrical Mfg. Co., Spring City, PA (US)

(72) Inventors: Daniel Kovalchick, Sinking Spring, PA (US); Bryan Rash, Pottstown, PA (US); Michael Greck, Spring City, PA (US)

(73) Assignee: SPRING CITY MFG. CO., Spring City, PA (US)

(21) Appl. No.: 14/817,552

(22) Filed: Aug. 4, 2015

Related U.S. Application Data
(60) Provisional application No. 62/039,093, filed on Aug. 19, 2014.

(51) Int. Cl. F21V 29/70; F21S 8/08; F21V 19/00; F21V 5/04; F21V 21/112; F21V 23/00; F21K 99/00; F21V 5/00

(52) U.S. Cl. CPC F21V 29/70; F21K 9/30; F21S 8/088; F21V 5/007; F21V 5/008; F21V 5/048; F21V 21/112; F21V 23/009; F21V 19/003; F21Y 2105/001

(57) ABSTRACT

A pendant mounted lighting fixture has a decorative housing that includes a cast metal body and two light engines. The body is a single-piece casting that may have a separate door. Each light engine contains LEDs on a circuit board in contact with the inner surface of the body. The body provides heat sink mass with heat dissipation through its outside surface. The light engines are may be mounted at acute angles such that the light from the two light engines is emitted in lobes that expand outside to create an asymmetric overall light profile. Each light engine may have an array of LEDs flat on the circuit board without raised reflectors. Each LED may be covered by a transparent dome lens. Refraction at the surface of the dome lenses directs the light from the LEDs into a desired distribution.

### RELATED APPLICATION

This application is related to and claims priority from U.S. Provisional Application No. 62/039093, filed Aug. 19, 2014, the disclosure of which is incorporated herein by reference in its entirety.

### FIELD OF THE INVENTION

The invention relates to the general field of outdoor lighting, and to the more specific field of LED lighting fixtures.

### BACKGROUND OF THE INVENTION

Light Emitting Diodes (“LEDs”) have several advantages for outdoor lighting over High Intensity Discharge (“HID”) light sources, such as long life, lower energy consumption, durability, cold weather performance, directional orientation of beam patterns, instant on/off and controlled dimming without color change. En particular, the directional nature of the LED light gives the ability to create asymmetric light beam emission patterns by orienting and directing multiple LED light engines within the fixture, rather than relying solely upon reflectors and focusing lenses as in conventional light sources.

A major concern, however, when designing an LED outdoor fixture, is effective heat management. Heat at the semiconductor domain junctions is a primary determinant in the life of the LED and in maintaining a consistent wavelength. LEDs function better and last longer at cold or cool temperatures, and deteriorate more rapidly with increased heat. The design effort to draw heat away from the junctions has often resulted in the LED circuit boards being attached to a finned heat sink, with natural air convection or fans used for cooling. In an outdoor light fixture, however, the ambient temperature may at times be relatively high, even at night. There may also be little natural air movement in or around the fixture, and little ventilation from within the fixture. Hence, convection heat transfer is limited.

In addition to the utilitarian design considerations, outdoor pole and wall mounted luminaires are often decorative pieces, mimicking ornate gas lanterns and early incandescent street and park lighting. Some of the most ornate fixtures are cast metal housings that incorporate the architectural design elements of the locale or historical periods. Replacing the light source in such fixtures with LED lighting is a particularly challenging task, and one that is addressed in this specification.

Conventional light sources of this sort, especially those with an electronics compartment, have had a roof fabricated by assembling several separate cast pieces. A single piece casting was avoided, partly because the resulting complicated shape was considered too difficult to cast to be worthwhile, where a fabricated roof allowed the individual components to be much simpler, and partly because the single piece casting was several times the size of any single piece for a fabrication. Luminaire manufacturers did not have, and had no reason to acquire, casting equipment capable of producing large castings that the manufacturers were not using and saw no reason to use.

These fabricated roofs did not have an access door to an interior electronics chamber because with a fabricated assembly, it was easy to make two or more of the parts separable for access to the space between them.

A major challenge in devising LED lighting fixtures is to ensure that the light from the LEDs is directed effectively and efficiently where it is desired. In particular, for street lighting, a light distribution pattern that extends along the street, and to a lesser extent out into the street, is often desired, with little or no light going back onto street-front properties behind the lamp or upwards.

Our earlier U.S. Pat. No. 8,104,929 (“the '929 patent”) is directed to an outdoor lighting fixture that uses LEDs as a light source. The fixture includes a decorative housing with a cast metal dome roof having an inner surface and an outer surface. A plurality of LED l t engines each contain a plurality of LEDs on a circuit board mounted on a conductive metal substrate. The substrate has a surface opposite the circuit board that is in conformal contact with a portion of the inner surface of the roof. The roof provides increased heat sink mass and the outer surface of the roof provides a heat dissipative surface area outside of the housing. Two of the LED light engines are placed along the inside walls of the dome roof, with one engine located at an acute angle to a line through the housing and the other engine at its complimentary angle to the line, such that the light from the two LEDs is emitted in lobes that cross within the fixture and expand outside of it to create an asymmetric overall light profile. The roof forms only a lamp chamber open downwards, and is thus a simple multi-part casting. The driver electronics are in a separate canister at the bottom of the fixture.

While the design in the '929 patent provides a vast improvement over the prior art fixtures, there is still room for further improvement.

### BRIEF SUMMARY OF THE INVENTION

One aspect of the invention provides a light source in which the cast metal dome roof is cast in a single piece, optionally with the exception of an access panel or door for an internal chamber containing electrical and/or electronic equipment.

The single piece casting has been avoided in the past, because it was considered too difficult to be worthwhile. Conventional light sources of this sort, especially those with an electronics compartment, have therefore had a roof fabricated by assembling several separate cast pieces. However, we have found that the single piece casting greatly improves the efficiency of the roof as a heat sink for the light engines, because any joint, however carefully designed and assembled, significantly interrupts the heat flow.

An electronics compartment in the roof is especially advantageous for a bishop's crook, wall-mounted, or other pendant lamp, in which the support is attached to the top of the roof. The incoming power supply can then be fed directly into the electronics compartment, and the outgoing power supply can be fed directly to the light engines, with little or no visible wiring. Such lamps typically have metal frame members supporting the roof, and the incoming power supply cables can easily be concealed by such frame members. Cooling of the power supply and control electronics is also not a problem, because they are installed in a compartment the walls of which are designed to act as a heat sink.

In an embodiment, each light engine contains an array of LEDs on a circuit board. For outdoor street lighting, the color temperature of the white light is preferably in the CCT 2750-6000 range, with the warmer color range being preferred. The light engines are circuit board blocks containing a circuit board with LEDs that is mounted on a metal substrate.

The LED circuit board may be printed on or attached to the metal substrate, sometimes described as a metal-core printed circuit board. The circuit board may be coated with a dielectric material. The metal substrate is preferably a steel or aluminum plate with its surface opposite the direction of LED light emission. The inner surface of the dome roof is dimensioned for an abutting conformal contact with the circuit board, so that the dome roof provides a substantially increased heat conducting mass compared to the mass of the circuit board substrate alone. In a preferred embodiment, the circuit board substrate is flat and the dome roof is cast to have flat platform surfaces at the inner locations where the light engines are attached. The inside surface of the dome roof may also have ribs abutting the sides of the circuit boards to increase the contact surface and create a larger path for heat migration from the circuit board into the roof.

The outer surface of the dome roof, including the walls of the electrical compartment, provides a large heat-dissipative surface area outside of the housing, such that heat can be conducted over the roofs wide surface area and given off as convection to the atmosphere. This ability for rapid convection loss of heat to the atmosphere outside of the fixture helps to maintain an effective temperature gradient to draw heat away from the LED circuit boards.

Using this cooling technology, an array of LEDs with a total electrical power consumption in the range 60-100 watts can replace a 150 watt metal halide lamp with equivalent lighting effect, yet have an average operating life of 70 percent or better lumen maintenance after 50,000 hours operation.

Preferably the inner surface of the roof is cast to have flat mounting platforms at the desired light engine locations to accommodate the fiat circuit board bases. By correctly aligning the mounting platforms, this allows the multiple light engines to be oriented to produce any desired beam profile, including an asymmetric beam profile, from the fixture.

In a preferred example used to illuminate a street or pathway, two light engines are oriented to generate two crossing beams that create an emission pattern with a long axis along and over the street or path, and a short axis across the street or path. On the short axis, the emission pattern is more in front of the lamp than behind (where the “front” is the direction across to the far side of the street) to keep light from intruding into premises located behind the lamp post. This is accomplished by mounting the two light engines along the inside wall of the dome roof not parallel to each other and facing directly along the street, but each angled out into the street by approximately 25 degrees, and downwards approximately 25 degrees, in combination with suitable dome lenses over the LEDs or other light emitting elements. The resulting emission pattern then has mirror symmetry about the short axis, but is asymmetrical from front to back.

A transformer and LED driver to provide and regulate electrical power to the LED light engine or engines is located inside the electrical compartment in the roof of the housing, where it can receive line power from utility wires running inside the lamp pole and through a bishop's crook support into the top of the housing. The driver converts the utility power, typically 110 V or 220 V AC to DC power at levels appropriate for the LED operation, and controls the levels to provide ON/OFF switching, dimming and other power control features.

An electrical power cable then extends from the driver to the light engine or engines. The cable preferably has a quick disconnect plug into a wiring harness for the light engines.

Another aspect of the present invention provides a light source wherein each of the two LED light engines comprises an array of LEDs mounted flat on the circuit board without raised reflectors surrounding the LEDs, each LED being covered by a transparent dome lens shaped so that refraction at the surface of the dome lenses directs the light from the LEDs into a desired distribution pattern.

In an embodiment, each of the two light engines covers half of the desired light distribution pattern in a mirror-symmetrical arrangement, optionally with some overlap at the center.

In an embodiment, all the LEDs in one light engine have identically shaped transparent domes, with the transparent domes of the other light engine being of the mirror symmetrical shape.

In an embodiment, each dome has a plurality of curved facets, each facet directing part of the light from the LED to a respective part of the desired distribution pattern.

Preferred embodiments of the '929 patent had each LED surrounded by a cup-shaped reflector. That gave very good control of the reflected light, but we found that a significant amount of light could escape over the rims of the reflectors, outside the desired distribution pattern. That unreflected light was difficult to control. With the dome lenses, we are now able to control all the emitted light from the forward hemisphere, giving a still further improvement in the efficiency and effectiveness of the lighting.

The foregoing and other features of the invention and advantages of the present invention will become more apparent in light of the following detailed description of the preferred embodiments, as illustrated in the accompanying figures. As will be realized, the invention is capable of modifications in various respects, all without departing from the invention. Accordingly, the drawings and the description are to be regarded as illustrative in nature, and not as restrictive.

### BRIEF DESCRIPTION OF THE DRAWINGS

The above and other aspects, features, and advantages of the present invention may be more apparent from the following more particular description of embodiments thereof, presented in conjunction with the following drawings. In the drawings:

FIG. 1 is an exploded perspective view of one form of lamp.

FIG. 2 is a cross-sectional. view of the lamp shown in FIG. 1.

FIG. 3 is a perspective view of a light engine of the lamp shown in FIG. 1.

FIG. 4 is a front view of a lens of one of the light engines of the lamp shown in FIG. 1.

FIG. 5 is a longitudinal cross-sectional view of another form of lamp.

### DETAILED DESCRIPTION OF THE DRAWINGS

A better understanding of various features and advantages of the present methods and devices may be obtained by reference to the following detailed description of illustrative embodiments of the invention and accompanying drawings, Although these drawings depict embodiments of the contemplated methods and devices, they should not be construed as foreclosing alternative or equivalent embodiments apparent to those of ordinary skill in the subject art.

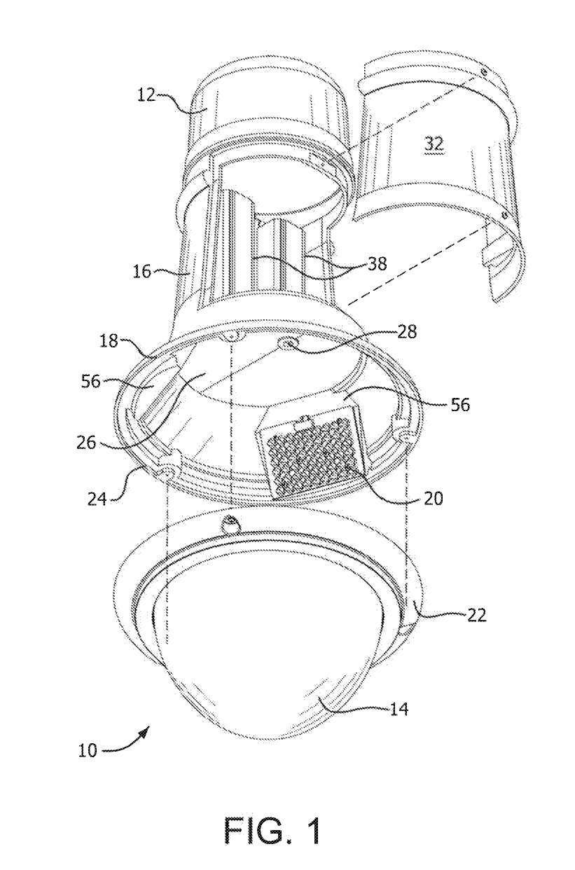

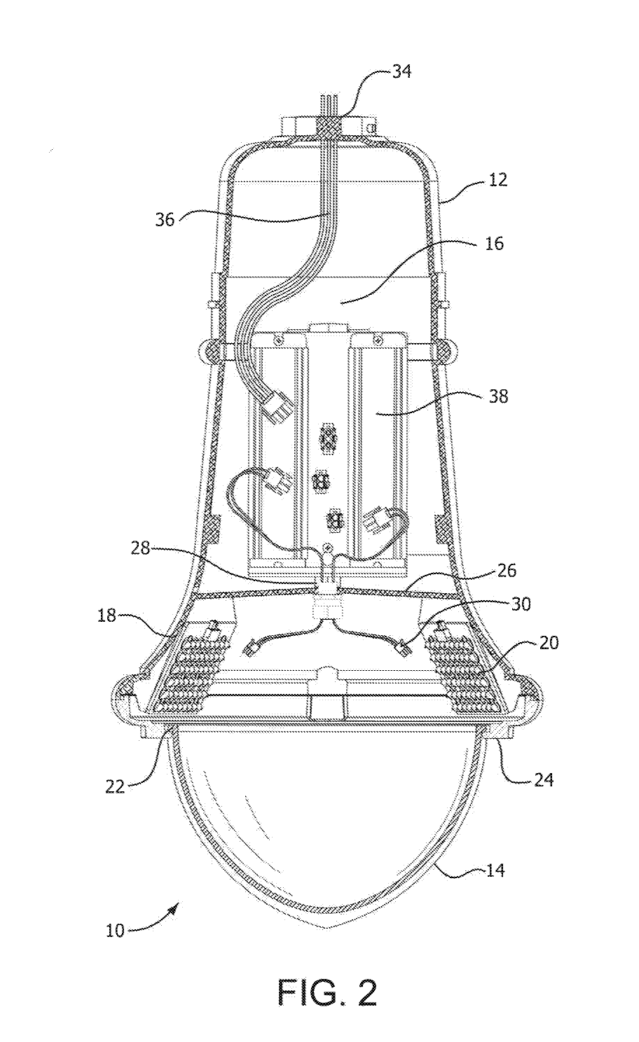

Referring to the accompanying drawings, and initially to FIGS. 1 and 2, one form of lamp embodying aspects of the invention, indicated generally by the reference numeral 10, comprises an upper dome or body 12 of cast metal, and a lower transparent globe 14. The body 12 has an upper portion 16 forming a driver chamber, and a lower portion 18 forming a lamp chamber for two or more light engines indicated generally 20, which are mounted to the inside of the wall of the lamp chamber 18, as described in more detail below. The lamp chamber 18 is open downwards towards the transparent globe 14. The entire metal body 12 forms the roof of the lamp chamber 18. The rim 22 of the globe 14 is attached and preferably sealed to the rim 24 of the lamp chamber 18 in any convenient way, which may be conventional.

The lamp chamber 18 is separated from the driver chamber 16 by a partition 26, which is preferably sealed at its edges to or formed integral with the inside of the wall of the body 12. The partition 26 is provided with a sealing gland (aperture) 28 through which electrical wiring 30 passes from the driver chamber 16 to the light engines 20 in the lamp chamber 18. The partition 26 is dished upwards in the middle, and one or more weep holes are provided in the wall of the body 12 just above the partition 26, so that any moisture that finds its way into the driver chamber 16 naturally drains out through the weep holes.

The driver chamber 16 is provided with a door 32, which is removably attached to the body 12 in any conventional manner Access to the driver chamber 16 and lamp chamber 18 is generally required by only maintenance personnel, so the fastenings used may be screws or other devices not easily removed without tools. At the top of the body 12 is a connector 34 that mounts the lamp 10 to a support and permits an electrical feed 36 to enter the driver chamber 16, while sealing against weather and other environmental intrusions. The support may comprise a hollow pipe with the electrical feed 36 inside the pipe. That present embodiment is constructed so as to be especially suitable for top-mounted “pendant” lamps, including wall-mounted lamps and lamp posts with a bishop's crook shaped lamp.

The driver chamber 16 contains electrical and electronic circuitry 38 to convert the power delivered by the electrical feed 36 to a form suitable for use by the light engines 20, which in this embodiment are arrays of LEDs, and to control the LEDs. The incoming power is typically 110 or 220 volts, 50 or 60 Hz AC, depending on the geographical area where the lamp is intended to be used. LEDs typically require a current regulated DC supply at around 3 volts, depending on the type of LED, although if LEDs are wired in series the actual supply voltage required is determined by the number of LEDs in the series. The current through each LED may be predetermined, or the brightness may be variable by regulating the current, the number of LEDs powered, or duty cycle modulation. The circuitry 38 may also include a time clock, ambient light sensor, or other controls for when and/or how brightly the light engines 20 are to be illuminated. The circuitry 38 may be conventional, and in the interests of conciseness is not described in detail. The circuitry 38 may be mounted directly onto the inside of the lamp body 12, or onto mounts cast integrally with the lamp body 12, to improve transfer of heat from the circuitry 38 to the lamp body 12.

The entire body 12, except for the door 32 and optionally the partition 26, is made from a single-piece casting of aluminum 356 alloy or other suitable metal. The partition 26 can be included in the single-piece casting by using a separate mold core for the interior of the driver chamber 16. That separate mold core is supported and located during casting through a bridge to the exterior that forms the opening for the door 32. As a result of the single-piece casting, heat generated by the light engines 20 and transmitted to the wall of the light chamber 18 is easily conducted over the entire body 12, and dissipated to the external atmosphere. Heat generated by components in the driver chamber 16 is also easily spread over the entire body 12 and dissipated to the external atmosphere. This is in contrast to conventional lamps, including our own earlier lamps, where the structure corresponding to lamp body 12 was typically a fabrication from several pieces of metal screwed, bolted, or otherwise fastened together. With those conventional designs, however carefully the joints were designed, the joints provided a significant impedance to heat flow, greatly reducing the effectiveness of the lamp body as a whole as a heat sink. That reduced effectiveness was tolerated, because it was believed that the one-piece casting now proposed was not practical.

As shown, the opening in the driver chamber 16 on which the door 32 is attached, may extend about half-way around the circumference of the housing 12. A step may be formed in the driver chamber portion of the housing so that the attachment of the door 32 to the housing 12 results in a smooth appearance. As such, as heat is conducted through the housing 12 from the lamp chamber 18, the heat passes along to the driver chamber portion and upwards to the top portion of the housing, all the while dissipating heat through convection.

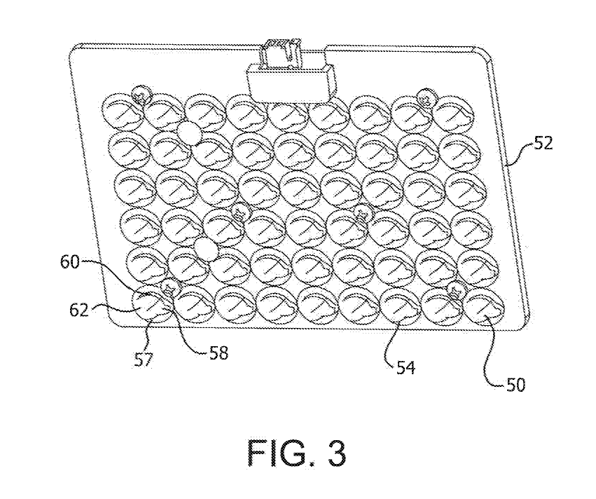

Referring now also to FIG. 3, each light engine 20 comprises an array of LEDs 50 mounted on a circuit board 52, each LED 50 being covered by a lens 54, preferably hemispherical in shape. The lenses 54 are molded from acrylic plastic or other suitable transparent material, preferably in a single sheet covering the whole active area of the circuit board 52. Each actual LED chip 50 lies essentially flat on the surface of the circuit board 52, emitting light into a hemisphere. The associated lens 54 preferably occupies the whole hemisphere, refracting almost all the rays of light from the LED chip 50 into useful directions. The circuit boards 52 are metal-core printed circuit boards, consisting essentially of a metal substrate, with the front face that bears the LEDs coated with a dielectric material and with the actual circuitry printed on or attached to the surface. The metal core may act as a ground and/or electrical return, further simplifying the construction. The metal substrate is preferably a steel or aluminum plate with an exposed metal surface at the back, opposite the direction of LED light emission. The circuit boards 52 are mounted on pads 56 cast into the inside of the lamp chamber 18, allowing heat conduction from the circuit boards 52 to the pads 56 over the whole area of the circuit boards. The pads 56 both determine the overall alignment of each light engine 20 and provide good thermal conduction from the circuit board 52 to the outside of the lamp body 12. The inside surface of the roof of the lamp chamber 18 may also have ribs abutting the sides of the circuit boards 52 to increase the contact surface and create a larger path for heat migration from the circuit boards 52 into the lamp body 12.

As may be seen in FIG. I, the pads 56 are not directly opposite each other, but are angled so that the light engines 20 face forwards (out of the paper in FIG. 2) and downwards. Each pad is positioned to face along a diameter of the lamp body 12, so that in plan view their physical separation round the circumference of the lamp matches the angular separation of their output beams. As shown in the drawings, the pads 56 are about 130° to 160° apart in plan view (so that the two pads are at between about 10°-25° and between about 155°-170° to the notional direction of a street that is being illuminated) and are angled between about 20°-25° down from the horizontal. The light engines 20, thus, produce two pools of light below, in front of, and to either side of the position of the lamp 10. When used as a street lamp, the lamp 10 is then mounted so that the street runs from left to right in the plane of the paper in FIG. 2. The pool of light then extends along the street, with little light being thrown backwards into premises behind the lamp.

As may be seen in FIG. 3, each lens 54 is shaped in several distinct curved facets 57, 58, 60, 62, each of which acts as a lens and produces a beam of light, and the combined light of the beams determines the exact shape, size, and intensity distribution of the resulting pool of light. All of the lenses 54 on one circuit board 52 are preferably identical, and their output beams combine. (The light engine 20 is only a few inches wide, so for a street lamp, the lateral displacement between the different LEDs is negligible.) The sheets of lenses 54 of the two light engines 20 are mirror images of each other, so that the combined pool of light is mirror symmetrical on either side of the lamp 10.

An LED without a shaped refractor typically produces most of its light output within 60° of the direction perpendicular to the circuit board. Thus, very little refraction of the bottom part of the light distribution is necessary. The bottom lens facet 57 may thus approximate to a spherical surface centered on the LED chip 50. However, the top part would then be up to about 35° above the horizontal, and in a street lamp, that light would be wasted. The upper lens facets 58, 60, 62 are shaped to redirect much of that light down and sideways to places where it is actually desired.

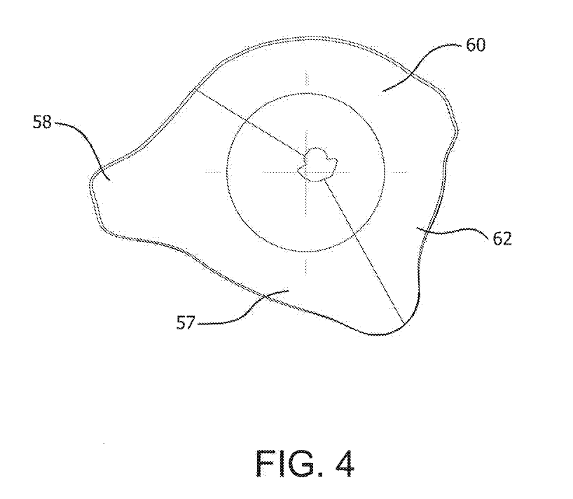

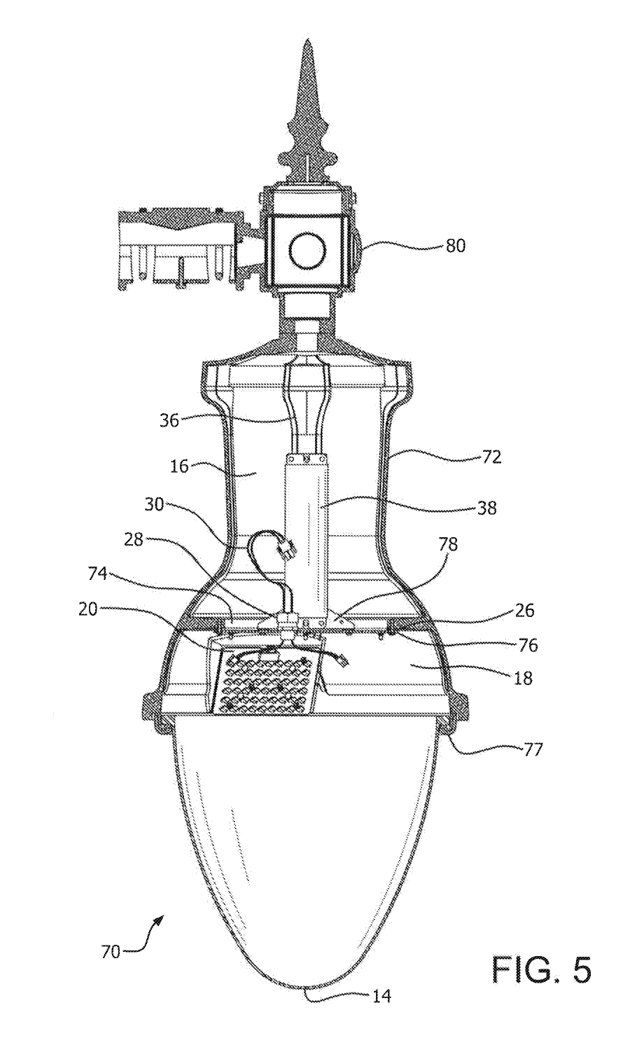

Referring now to FIG. 5, a second form of lamp indicated generally by the reference numeral 70 is largely the same as the lamp 10 shown in FIGS. 1 to 4. In the interests of conciseness, identical parts will be referred to by the same reference numerals, and the description of identical or similar parts will not be unnecessarily repeated. In the lamp 70, the unitary body 72 does not have a door or an opening for a door into the driver chamber 16 from the side. Instead, the partition 26 that separates the lamp chamber 18 from the driver chamber 16 has an opening 74, which is closed by a door or access panel 76. The door 76 is removable from below, after first removing the globe 14, and is secured to the partition 26 at the rim of the opening 74 by screws or other suitable fastenings. The choice of fastening may be influenced by the desirability of permitting easy access to the driver chamber 76 by authorized maintenance personnel, or of hindering easy access by unauthorized personnel. The globe 14 is secured by a removable ring 77 forming the rim of the body 72, which may also be made more or less easy to remove.

The driver circuitry 38, or a substantial module thereof, is mounted by a bracket 78 on the inside of the door 76, so that when the door 76 is removed, the driver circuitry 38 is removed with the door, for easy access. An appropriate amount of slack is provided in the electrical feed 36 between the circuitry 38 and the external mounting connector 80 at the top of the lamp 70. The electrical wiring 30 that connects the driver circuitry 38 to the light engines 20 may pass through a separate sealing gland 28, also mounted in the door 76.

The light engines 20 may be similar in construction and arrangement to those shown in FIGS. I to 4. Only one of the light engines 20 is visible in FIG. 5, because the plane of section in FIG. 5 is perpendicular to that in FIG. 2.

The connector 80 shown in FIG. 5 is suitable for mounting the lamp 70, or the lamp 10, to a wall, and may include adjustments to allow the lamp to be accurately aligned with any of the line of the wall, a vertical direction, or a direction along or across a road, footway, or other area in front of the wall. The adjustments may be conventional and, in the interests of conciseness, are not further described. The connector 80 may be connected to the top of the unitary body 12 or 72 by welding or any other expedient method.

As an example of suitable dimensions for a street lamp, the lamp 10 shown in FIGS. Ito 4 may be about 24″ (60 cm) high excluding the globe 14, and 32″ (80 cm) high including the globe 14 and about 17″ (43 cm) in diameter at the widest point. Such a lamp 10 may have a body 12 with an external surface area of nearly 915 square inches (5,900 cm², excluding the door 32 and other components that are not part of the unitary lamp body 12). This surface area compares to 715 square inches in the comparable multi-piece fixture. The weight of the casting in a one piece unit is 26 pounds compared to 50 pounds in a comparable multi-piece fixture. The number of drilled and tapped connections are reduced by almost 50% from a comparable multi-piece fixture. The single-piece casting provides at least the same thermal heat dissipation as a comparable multi-piece fixture, at half the weight. As shown in the drawings, each light engine 20 has 54 LEDs 50 in a 6×9 array. The lamp 70 shown in FIG. 5 may be of similar size to the lamp 10.

Suitable LED chips for a street lamp are 1 watt CREE XTE LEDs, with a color temperature of 4250 K. The number of LEDs will depend on the power of each LED and on the desired light output. Decreasing the number of LEDs, either by switching or by omitting LEDs in manufacture, reduces the overall light output, with minimal effect on the beam shape. For economy of manufacture of a range of products, it is possible to use a single size of circuit board 52 and a single sheet of lenses 54, sized for the most powerful lamp 10, and not use all of the lenses for the less powerful lamps.

The globe 14 may have a textured or translucent external surface, to diffuse the outgoing light slightly, so that the LEDs are not visible from below as distinct points of light. That is especially desirable in historic districts, where the lamp is intended to resemble earlier types of lamp with a single large light source. The diffusion should not be so strong as to prevent the lamp 10 from forming the desired light distribution. However, that can, to some extent, be compensated for by designing the lenses 54 to produce a beam of light that, if not diffused, would be slightly too sharp.

While the foregoing written description of the invention enables one of ordinary skill to make and use what is considered presently to be the best mode thereof; those of ordinary skill will understand and appreciate the existence of variations, combinations, and equivalents of the specific embodiment, method, and examples herein. The invention should therefore not be limited by the above described embodiment, method, and examples, but by all embodiments and methods within the scope and spirit of the invention.

Although the embodiment has been described with reference to a usual orientation in use, with the mounting point 34, 80 at the top and the globe 14 at the bottom, the lamp may be mounted in other orientations, and may be shipped or stored in any orientation.

Accordingly, reference should be made to the appended claims, rather than to the foregoing specification, as indicating the scope of the invention.

1. An outdoor lighting fixture, the fixture comprising:
a decorative housing that includes a single piece cast metal body having an inner surface and an outer surface, the single piece housing body including a lower portion forming a dome roof of a lamp chamber, and an upper portion forming a driver chamber;
a plurality of light-emitting light engines, mounted on and in thermal communication with the inner surface of the lower portion of the body, the light engines configured to emit light into a desired distribution pattern; and
electrical or electronic circuitry mounted in the driver chamber for the supplying power to or controlling the light engines;
wherein the body provides a heat sink mass for heat generated by the light engines, and the outer surface of the body provides a heat dissipative surface area to the ambient air outside of the housing.

2. The lighting fixture of claim 1, wherein each light engine contains a plurality of light emitting elements on a circuit board.

3. The lighting fixture of claim 2, wherein there are two light engines on the inside walls of the body, the light engines being located obliquely to one another, such that the light from the two light engines is emitted in lobes that cross within in the fixture and expand outside of the fixture; and wherein the light emitting elements do not have raised reflectors surrounding the light emitting elements, and each light emitting element is covered by a transparent dome lens shaped so that refraction at the surface of the dome lenses directs the light from the light emitting elements into the desired distribution pattern.

4. The lighting fixture of claim 2, wherein there are two light engines and each of the light engines covers half of the desired light distribution pattern in a mirror-symmetrical arrangement, and wherein all the light emitting elements in each light engine have identically shaped transparent domes, and wherein the shapes of the transparent domes of the two light engines are symmetrical mirror images of one another.

5. The lighting fixture of claim 2, wherein each light emitting element is covered by a transparent dome lens shaped so that refraction at the surface of the dome lenses directs the light from the light emitting elements into the desired distribution pattern, and wherein each dome has a plurality of curved facets, each facet directing part of the light from the light emitting element to a respective part of the desired distribution pattern.

6. The lighting fixture of claim 5, wherein each light engine comprises a sheet of transparent material having a plurality of said dome lenses molded into it.

7. The lighting fixture of claim 2, wherein the light emitting elements are light emitting diodes.

8. The lighting fixture of claim 1, wherein there are two light engines and each of the light engines covers half of the desired light distribution pattern in a mirror-symmetrical arrangement.

9. The lighting fixture of claim 1, wherein the single piece cast metal body includes a partition separating the driver chamber from the lamp chamber.

10. The lighting fixture of claim 1, further comprising an access panel or door attached to the body for providing access to the driver chamber.

11. The lighting fixture of claim 10, wherein the access panel or door is in an exterior wall of the driver chamber.

12. The lighting fixture of claim 10, wherein the access panel or door is in a partition separating the driver chamber from the lamp chamber.

13. An outdoor lighting fixture, the fixture comprising:
a decorative housing that includes a cast metal body cast in a single piece and having an inner surface and an outer surface; and
a plurality of light engines, each light engine containing a plurality of light emitting elements on a circuit board mounted in thermal communication with a portion of the inner surface of the single-piece body, wherein the body provides heat sink mass and the outer surface of the body provides a heat dissipative surface area outside the housing;
wherein two said light engines are placed along the inside walls of the body, angled such that the light from the two light engines is emitted in lobes; and
wherein the single piece cast metal body includes a lower portion forming a dome roof of a lamp chamber containing the light engines, and an upper portion forms a driver chamber containing electrical or electronic circuitry for supplying power to or controlling the light engines.

14. The lighting fixture of claim 13, wherein the light engines are mounted on an angle such that the emitted lobes cross within in the lamp chamber and expand outside of the fixture to create an asymmetric overall light profile.

15. The lighting fixture of claim 13, wherein the single piece cast metal body includes a partition separating the driver chamber from the lamp chamber.

16. The lighting fixture of claim 13, further comprising an access panel or door mounted to the upper portion for permitting access to the driver chamber.

17. The lighting fixture of claim 16, wherein the access panel or door is in an exterior wall of the driver chamber.

18. The lighting fixture of claim 16, wherein the access panel or door is in a partition separating the driver chamber from the lamp chamber.

19. The lighting fixture of claim 16, wherein the light emitting elements are light emitting Diodes.

20. An outdoor lighting fixture for a Bishop's Crook-type lamp, the fixture comprising:
a decorative housing having a single piece cast metal body with an inner surface and an outer surface, the housing including a lower portion with a partition wall and a sidewall that is attached to and flares outwardly from the partition wall to an open bottom, the combination of the partition wall and the sidewall defining a lamp chamber, and an upper portion having an upper sidewall and a closed top wall attached to the upper sidewall, the upper side wall and the top wall defining a driver chamber, the partition wall separating the lamp chamber from the driver chamber, the inner surface including two sloped mounting pads on the sidewall or partition wall of the lamp chamber, the mounting pads being mounted so as to permit conduction of heat to the body, the body having an aperture formed in the upper sidewall of the upper portion for permitting access to an interior of the driver chamber, the housing including a door removably attached to the housing so as to close the aperture into the driver chamber;
at least two LED light engines, each light engine containing a plurality of LEDs on a circuit board mounted on one of the mounting pads so as to provide thermal conduction from the circuit board to the inner surface of the body, the body providing a heat sink mass for conducting heat to the outer surface of the body for heat dissipation; and
electrical or electronic circuitry mounted in the driver chamber and in electrical communication with the light engines for controlling their operation.
